(19) United States
(12) Patent Application Publication
(10) Pub. No.: US 2010/0115591 A1
(43) Pub. Date: May 6, 2010

(54) METHOD AND SYSTEM FOR AUTHENTICATING USERS WITH OPTICAL CODE TOKENS

(75) Inventor: Yana Z. Kane-Esrig, Madison, NJ (US)

Correspondence Address: FAY SHARPE/LUCENT, 1228 Euclid Avenue, 5th Floor, The Halle Building, Cleveland, OH, 44115-1843, US

(73) Assignee: Lucent Technologies Inc.

(21) Appl. No.: 12/262,402

(22) Filed: Oct. 31, 2008

(51) Int. Cl. G06F 21/00

(52) U.S. Cl. 726/5

(57) ABSTRACT

A method and apparatus are provided for authenticating users using cell phones or other mobile devices. The system finds particular application in authenticating users seeking to retrieve sensitive (e.g. personal, medical, safety, . . . etc.) information.

### BACKGROUND OF THE INVENTION

This invention relates to a method and apparatus for authenticating users using cell phones or other mobile devices, and finds particular application in authenticating users seeking to retrieve sensitive (e.g. personal, medical, safety, . . . etc.) information.

By way of background, consumers desire an inexpensive, easy-to-use method for authenticating themselves to access their own sensitive data. Oftentimes, this data is stored electronically in, for example, various service provider web accessible electronic storage systems or streamed in real time. For example, a consumer may need to authenticate himself to access his own healthcare records stored in an “electronic vault”. As a further example, a consumer may need to authenticate himself to view the output of a security video camera in his own home. There are other situations where an improved authentication system is desired. For example, a consumer may wish to enable people in certain jobs (e.g. emergency medical responders) to access his data easily and quickly—even if he is not able to assist them.

There are existing solutions to this problem. However, those known are insufficient.

Prior solutions include the use of a login and password. This is inexpensive; however, if the login and password are simple and easy for the consumer to remember, then they tend to be easy for someone to decipher. If they are difficult to decipher, then they tend to be difficult to remember—so the consumer writes them down. This compromises

Prior solutions also include the use of a login and password—complemented by an electronic token (for example, an RSA Secure ID) that generates long sequences of numbers. The consumer is required to enter this string of digits in addition to the password. The advantage is that it is more secure. In order to break it, any hacker must steal the physical token, not just guess the login and password. The disadvantages are that it is expensive (e.g. to distribute and support the tokens) and inconvenient (e.g. the tokens are fragile and they have to be mailed periodically for maintenance and entering the string of digits as part of the password is annoying).

Biometrics (e.g. using a consumer's voice or fingerprint or face to authenticate) has also been used. The consumer does not need to carry any form of ID (e.g. their own body identifies them); however, voice or face based identification is generally not reliable, and fingerprint identification requires special hardware (e.g. a fingerprint reader). Also, this form of authentication is not acceptable to some consumers.

Many consumers already carry with them mobile communication devices (e.g., cellular phones) that are equipped with some form of optical scanner (e.g., built in photo camera). Each such device is uniquely identifiable (e.g., has its own unique phone number, identification number or code and/or IP address). It would be desirable to take advantage of the uniqueness of the mobile devices to overcome some of the above-mentioned difficulties.

### SUMMARY OF THE INVENTION

A method and apparatus for authenticating users with optical tokens are provided.

In one aspect of the presently described embodiments, the method comprises receiving an image of the optical token from the mobile device , verifying that the optical token and the mobile device are associated with a user, allowing access to the information if the optical token and the mobile device are associated with the user, and, denying access to the information if either the optical token or the mobile device are not associated with the user.

In another aspect of the presently described embodiments, the receiving further includes receiving a password, the verifying includes verifying that the password is associated with the user and the allowing or denying access is also based on whether the password is associated with the user.

In another aspect of the presently described embodiments, the receiving further includes receiving a second optical token, the verifying includes verifying that the second optical token is authorized for the user and the allowing or denying is also based on whether the optical token is authorized for the user.

In another aspect of the presently described embodiments, the optical token is a bar code.

In another aspect of the presently described embodiments, the second optical token is a bar code.

In another aspect of the presently described embodiments, the mobile device is also associated with an authorized third party.

In another aspect of the presently described embodiments, the second optical token is electronically produced.

In another aspect of the presently described embodiments, the system comprises at least one database having stored therein the information, and, an authentication server operative to receive an image of the optical token from the mobile device, verify that the optical token and the mobile device are associated with the user, allow access to the information in the at least one database if the optical token and the mobile device are associated with the user and deny access to the information in the at least one database if the optical token or the mobile device are not associated with the user.

In another aspect of the presently described embodiments the server is further operative to receive a password, verify that the password is associated with the user, and allow or deny access based on whether the password is associated with the user.

In another aspect of the presently described embodiments, the server is operative to receive a second optical token, verify that the second optical token is authorized for the user and allow or deny access based on whether the second optical token is authorized for the user.

In another aspect of the presently described embodiments, the optical token is a bar code.

In another aspect of the presently described embodiments, the second optical token is a bar code.

In another aspect of the presently described embodiments, the mobile device is also associated with an authorized third party.

In another aspect of the presently described embodiments, the second optical token is electronically produced.

In another aspect of the presently described embodiments, a means is provided to implement the method.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated In the accompanying drawings in which:

FIG. 1 is a network into which the presently described embodiments may be incorporated; and,

FIG. 2 is a flow chart illustrating one method according to the presently described embodiments.

### DETAILED DESCRIPTION

The presently described embodiments are related to a system and method for allowing secure access to sensitive information stored in a network. In this regard, the presently described embodiments allow a user or consumer to enter information about, for example, his or her health (allergies, blood type, current medications, etc.) and store it an electronic data vault provided by any of a variety of different entities including, for example, a cellular service provider. Other types of information may also be stored, e.g. financial, security, etc. Using the presently described embodiments, the user or consumer is able to access this data using his or her cell phone and, possibly, devices other than a cell phone, by using an authentication procedure provided and administered by, in at least one form, the cellular service provider. In one form, the user or consumer may wear or possess a unique optical token or code printed on a plastic tag (e.g. as a bracelet or glued to his watch strap). The user or consumer can use the combination of the tag and cell phone or other device to authenticate himself or herself in order to access health or other data securely.

The consumer is also able to give permission to third parties such as emergency responders (e.g., medical personnel) to access this data on their own devices (e.g., their own cellular phones) in an emergency quickly and easily and without the need for consumer's assistance. Emergency personnel whose cellular phones or other mobile devices are registered with the service provider can also access the consumer's health data via the tag (or other optical token) and their cellular phones or other mobile devices. The result is that the user or consumer has stronger protection than just a login and password to protect sensitive data from unauthorized access.

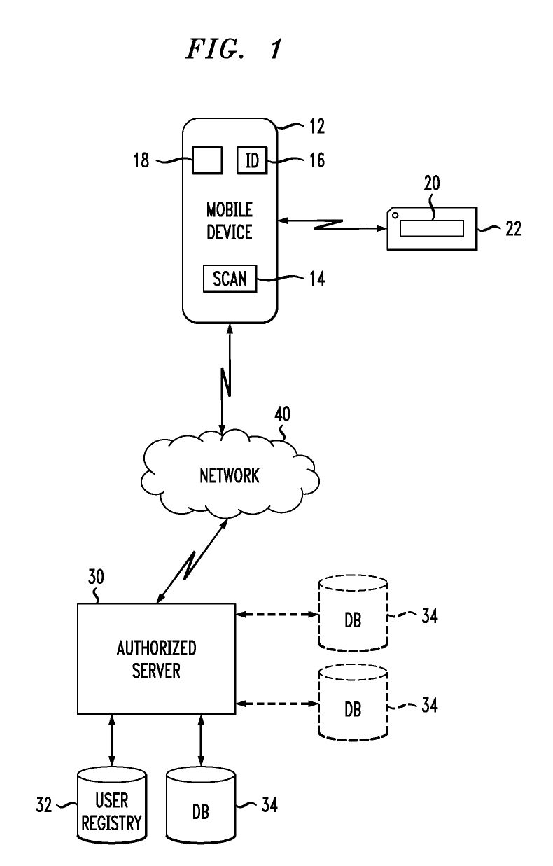

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, Figure lillustrates a system 10. The system 10 includes use of a mobile device 12 having an identification register 16, an optical scanner or camera 14 and an authentication button 18. The mobile device 12 can be used to generate an image of an optical token or code 20. The token or code is representatively shown but may take a variety of forms such as a bar code that may be printed on a tag 22. The tag 22 (or alternative devices such as a bracelet or card) may also take a variety of forms. The network 40 with which the mobile device 12 communicates also is associated with an authorized server 30. The authorized server 30 is associated with a user registry 32 and an information database 34.

This device 12 is shown as a mobile device or a cell phone so the service provider who runs the communication network is sometimes referred to herein as a cellular service provider. However, any other device that has a scanner or camera 14 and that can communicate with a service provider's communications network whenever the consumer needs to be authenticated may be used. A cell phone number is referred to herein for convenience but, again, it can be an IP address or any other digital address or identification number that uniquely identifies the specific individual communication device that the specific consumer carries with him or her. In some embodiments, this identification data may be stored in the identification register 16.

An objective of the presently described embodiments is to equip each consumer with an optically readable token or code 20 (e.g., a bar code, OR code or any other form of easy to print graphical identification pattern 20). The code 20 may take a variety of different forms; however, it is unique to each individual consumer. In at least one form, such a code 20 is cheaply and easily printed and distributed on a plastic bracelet or keychain tag or a wallet card or similar object that the consumer can carry with him or her easily.

It should be understood that the configuration of FIG. 1 is merely exemplary in nature. The network 40 may take a variety of known forms. Likewise, the authorized server 30 may take on a variety of different configurations, and be implemented in a variety of different environments. For example, the server 30 may be incorporated in a switching element.

Also, the user registry 32 will, in at least one form, include user identification information such as a mobile or phone number, IP address or other digital address or identification number and the optically readable code 20 (or data representing the code) associated with the user. The registry 32 could be a stand-alone database or configured as fields in, for example, a subscriber database of a service provider. The user registry 32 may also be incorporated into the server 30 or the database 34.

Along these same lines, the database 34 may take a variety of forms, or be configured as multiple databases (as shown in phantom) to accommodate the various types of information stored therein. In one form, the database 34 stores information for a user, e.g. medical information, banking or financial information, security information, etc. In another form, the database 34 also stores information (e.g. phone numbers, identification codes or numbers, optical codes (if available), etc.) relating to authorized third parties or personnel, such as emergency personnel, allowed to access information for a particular user. In still another form, the database 34 (or another database) is configured to store a list of personnel such as emergency personnel that could be authorized to access information of any user and/or information on such personnel (e.g. phone numbers, identification codes or numbers, optical codes (if available), etc.). In one form, this information is provided by a service provider; however, it should be appreciated that cooperation among at least the service providers, users and/or emergency authorities would be advantageous to allow for accurate and efficient population of such database fields.

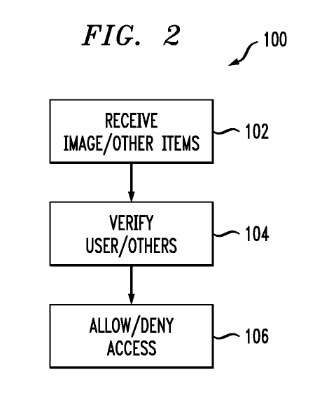

FIG. 2 is a flow chart of an example method 100 according to the presently described embodiments. It should be appreciated that such a method 100, as well as other methods contemplated by the presently described embodiments, may be implemented using a variety of hardware configurations and software techniques. In one form, software routines implementing the methods contemplated herein are stored and run on the authentication server 30; however, other alternatives and network solutions are possible.

With reference to FIG. 2, when the user or consumer wishes to authenticate himself or herself in order to access sensitive data using the cell phone or mobile device 12, the consumer “scans” (e.g., takes a picture of) the code 20 (e.g. on a tag or bracelet) using the scanner 16 of the cell phone 12. The user then will press the “authenticate” button 18 (e.g. which can be a “soft” button or an actual physical button) on the phone 12 and the picture or image of the code 20 will be sent to the authentication server 30 on the service provider's network 40. The authentication server 30 will receive the code 20 (at 102) and other information items such as the cell phone number (or other identification code) of the device 12 that transmitted the code 20. A verification process is then accomplished (at 104) using the code and the phone number, for example. If both the optical code and the phone number match the consumer's record stored in the user registry 32, then the user is authenticated and allowed to access the database 34 (at 106). Of course, if no match is found, access to the database is denied and a message is sent back to the user indicating that the request is denied.

Note that, in order to break this security arrangement, an unauthorized user would have to both physically steal the consumer's cellular phone and steal or make a copy of the optical code on the bracelet.

In a further embodiment, the consumer also uses other items such as a password to access the data. Such other items are sent and received by the authentication server (as at, for example, 102). So, the combination of the optical code or token, the phone number and the password further ensures that the individual accessing the information is authorized. In this regard, the verification process 104 would also include verification of the password. Even though passwords alone are not particularly strong or convenient security measures, if a password is used in combination with a token and cell phone number or other identification item, one could use a weak or easy password.

In a further embodiment, with further reference to FIG. 2, suppose the consumer wishes to authenticate himself to, for example, a web site that he or she is accessing through a device other than a cell phone. For example, he or she is at a doctor's office and contacts the electronic vault via a portal web site in order to request that his or her own electronic health record be made available to the doctor's desktop computer. In this case, the request for identification is communicated by the web site to the cellular service provider. For example, the consumer can enter his login on that web site. The web site will generate and display an optically readable code that the consumer will “scan” with his cellular phone to let the cellular provider know that an authentication request is being made for this consumer by this web site. This code is sent to the service provider and received by, for example, the authentication server 30 (at 102). Then the consumer “scans” his own optical code, sends it to the service provider via a cell phone, and the authentication proceeds as before (e.g. at 102, 104). After the cellular service provider's server has authenticated the consumer using both optically readable codes, a cell phone number and, possibly, a password (e.g. at 104), it sends an authentication confirmation to the “electronic vault” web site. The website then allows the information to be downloaded to the desktop computer (e.g. at 106). Of course, if the user is not authenticated, access is denied. In a further embodiment, a consumer wishes to be able to view the output of an IP-connected video camera that monitors his home. The consumer wishes to be able to do that via a security service provider's web site and/or storage device that stores the video and/or security data. However, the consumer wants to have stronger protection for this sensitive data than simple login and password authentication. In this case, the consumer may register for the contemplated authentication service with his cellular service provider. The consumer is issued a plastic tag that can be kept, for example, in a wallet or on a key chain. Whenever the consumer wishes to see the output of his video camera on his or her cellular phone, the authentication procedure described herein is used. If the user wishes to view this video stream on some device other than a cell phone (e.g. his laptop), the above authentication procedure can also be used as described above in connection with the doctor office example of FIG. 2.

In a still further embodiment, suppose the consumer wishes to make it possible for people in certain jobs (e.g., emergency medical personnel) to gain access to electronic medical records quickly in an emergency, even if the consumer cannot help them. The consumer can enable “emergency over-ride feature” in his authentication service. This may be stored as part of a user profile in the user registry 32. The cell phone numbers of the authorized emergency medical personnel would be stored in cellular service providers authentication server's database as described above. It should be understood that the listing of authorized emergency personnel may take on a variety of forms. For example, the list of authorized personnel may be uniquely associated with a particular user or consumer e.g. one's personal physician. A listing of authorized emergency workers may also be a universal list of all emergency workers in a particular city, region, state, etc. Different authorized personnel may also have access to different types of information of a user. Such specifications could be configured into the system.

When an authorized emergency worker scans a consumer's optical code (on the consumer's bracelet) with emergency worker's cellular phone, the authentication server can verify that the consumer did allow an emergency over-ride and that the over-ride is being requested by an authorized emergency worker's cell phone once all the information is received (e.g. at 102 and 104). Therefore, the authentication server allows the consumer's data (e.g., medical records) to be accessed by the emergency worker's cellular phone (or similar device) (e.g. at 106). The authorized personnel, such as the emergency worker, may also have an optical token that could be scanned, sent, received and verified by the system (in similar manners as above) to provide even further security. Of course, the appropriate databases would also be updated to store the optical code or token information for each of the emergency workers, for example.

Of course, this configuration and system is not limited to emergency workers. Particularly where the stored information is not medical in nature, users may authorize other people to access the information. One example is a user authorizing law enforcement personnel to access security data. Another example is a user authorizing family members to access financial information.

The benefit of the presently described embodiments to the consumer includes greater security without sacrificing convenience and without sacrificing accessibility of vital information to emergency personnel

The benefit to a service provider such as a wireless or cellular service provider includes.
1) extra revenue for the authentication service,
2) the ability to use the authentication feature as a competitive advantage for services, such as implementing an electronic health data vault which would benefit from this more secure authentication; and
3) the ability of the cellular service provider to become an authentication service provider to many third party services, thus giving it a stronger role in the online ecosystem.

The presently described embodiments provide a system that is more secure. It is relatively easy for a hacker to break a simple static password. If the password is complicated and frequently changed, it is hard for the consumer to remember the password. Thus, the presently described embodiments describe, in one form, a plastic tag with an optical code printed on it which is cheaper to produce, distribute and maintain than an electronic token. It can be wearable or can be easily carried in a wallet (thus, not requiring the consumer to carry extra objects). It does not have to be protected from water. It does not require the consumer or the emergency responder to enter a long string of digits, thus being easier to use.

The presently described embodiments also provide a system that can be used reliably and cheaply with today's technology. It does not invade the consumer's personal space—consumers already are quite accustomed to plastic tags and cards with various codes that they use to identify themselves (e.g. credit cards, bar code “courtesy cards” used in grocery stores, etc.)

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of authenticating access to information via a mobile device having an optical scanner, the method comprising:
receiving an image of the optical token from the mobile device;
verifying that the optical token and the mobile device are associated with a user;
allowing access to the information if the optical token and the mobile device are associated with the user; and,
denying access to the information if either the optical token or the mobile device are not associated with the user.

2. The method as set forth in claim 1 wherein the receiving further includes receiving a password, the verifying includes verifying that the password is associated with the user and the allowing or denying access is also based on whether the password is associated with the user.

3. The method as set forth in claim 1 wherein the receiving further includes receiving a second optical token, the verifying includes verifying that the second optical token is authorized for the user and the allowing or denying is also based on whether the optical token is authorized for the user.

4. The method as set forth in claim 1 wherein the optical token is a bar code.

5. The method as set forth in claim 1 wherein the second optical token is a bar code.

6. The method as set forth in claim 1 wherein the mobile device is also associated with an authorized third party.

7. The method as set forth in claim 1 wherein the second optical token is electronically produced.

8. A system for authenticating access information via a mobile device having an optical scanner, a user possessing a unique optical token, the system comprising:
at least one database having stored therein the information; and,
an authentication server operative to receive an image of the optical token from the mobile device, verify that the optical token and the mobile device are associated with the user, allow access to the information in the at least one database if the optical token and the mobile device are associated with the user and deny access to the information in the at least one database if the optical token or the mobile device are not associated with the user.

9. The system as set forth in claim 8 wherein the server is further operative to receive a password, verify that the password is associated with the user, and allow or deny access based on whether the password is associated with the user.

10. The system as set forth in claim 8 wherein the server is operative to receive a second optical token, verify that the second optical token is authorized for the user and allow or deny access based on whether the second optical token is authorized for the user.

11. The system as set forth in claim 8 wherein the optical token is a bar code.

12. The system as set forth in claim 8 wherein the second optical token is a bar code.

13. The system as set forth in claim 8 wherein the mobile device is also associated with an authorized third party.

14. The system as set forth in claim 8 wherein the second optical token is electronically produced.

15. A system of authenticating access to information via a mobile device having an optical scanner, the system comprising:
means for receiving an image of the optical token from the mobile device;
means for verifying that the optical token and the mobile device are associated with a user;
means for allowing access to the information if the optical token and the mobile device are associated with the user; and,
means for denying access to the information if either the optical token or the mobile device are not associated with the user.

16. The system as set forth in claim 1 wherein the means for receiving further includes receiving a password, the means for verifying includes verifying that the password is associated with the user and the means for allowing or denying access is also based on whether the password is associated with the user.

17. The system as set forth in claim 1 wherein the means for receiving further includes receiving a second optical token, the means for verifying includes verifying that the second optical token is authorized for the user and the means for allowing or denying is also based on whether the optical token is authorized for the user.

18. The system as set forth in caim 15 wherein the optical token is a bar code.

19. The system as set forth in claim 15 wherein the second optical token is a bar code.

20. The system as set forth in claim 15 wherein the mobile device is also associated with an authorized third party.

21. The system as set forth in claim 15 wherein the second optical token is electronically produced.
